(19) United States
(12) Patent Application Publication
(10) Pub. No.: US 2013/0182451 A1
(43) Pub. Date: Jul. 18, 2013

(54) VEHICLE PLASTIC WINDOW

(71) Applicant: Toyoda Gosei Co., Ltd., Kiyosu-shi (JP)

(72) Inventors: Tatsuya OBA, Kiyosu-shi (JP); Tetsuya ARAKAWA, Kiyosu-shi (JP); Yasunobu TERAMOTO, Kiyosu-shi (JP)

(73) Assignee: TOYODA GOSEI CO., LTD., Kiyosu-shi (JP)

(21) Appl. No.: 13/738,026

(22) Filed: Jan. 10, 2013

(30) Foreign Application Priority Data
Jan. 16, 2012 (JP) 2012-006364

(51) Int. Cl. B60Q 1/00

(52) U.S. Cl. CPC B60Q 1/00
USPC 362/503

(57) ABSTRACT

A vehicle plastic window includes a plastic structure. The outer part of the vehicle plastic window is formed by a transparent outer plastic portion. The inner part of the vehicle plastic window is formed by an opaque inner plastic portion. The inner plastic portion is formed integrally with the outer plastic portion from the inner side by the two-color molding. A lamp installing portion is formed integrally with a rear inner plastic portion from the inner side. The lamp installing portion is provided for attaching a lamp, which emits light to the outside, to the vehicle plastic window. The rear inner plastic portion has a transmission portion, which transmits light from the lamp.

### BACKGROUND OF THE INVENTION

The present invention relates to a vehicle plastic window.

Windows made of inorganic glass are typically used as windows attached to bodies of vehicles. In recent years, windows made of transparent plastic, or plastic glass (organic glass) have been used. This type of vehicle plastic window is characteristically light and hard to break. A vehicle plastic window disclosed in Japanese Laid-Open Patent Publication No. 2000-301985 has a function for emitting light to the outside of a vehicle. The vehicle plastic window of the document includes a window portion made of a transparent plastic panel. A lamp installing portion is located on the inner side of the plastic panel. An opaque film is attached to a part of the outer surface of the plastic panel that corresponds to the lamp installing portion. To improve the appearance, the vehicle plastic window disclosed in the document employs the opaque film to conceal the lamp installing portion, which is located on the inner side of the film, when the vehicle plastic window is viewed from the outside.

However, since the film is attached to the outer surface of the plastic panel according to the above configuration, the film and the adhesion portion between the film and the plastic panel are directly subject to influence of wind, rain, and external forces. After being subject to influence of wind, rain, and external forces for an extended period of time, the film may be peeled off the plastic panel. As a result, the lamp installing portion becomes visible from the outside, which degrades the appearance.

### SUMMARY OF THE INVENTION

Accordingly, it is an objective of the present invention to provide a vehicle plastic window that maintains the function for concealing a lamp installing portion from the outside for an extended period of time.

To achieve the foregoing objective and in accordance with one aspect of the present invention, a vehicle plastic window attached to a body of a vehicle is provided. The vehicle plastic window is formed by a plastic structure and has a lamp installing portion in which a lamp for emitting light to the outside of the body is installed. The plastic window includes a transparent outer plastic portion, which forms an outer part of the plastic structure, and an opaque inner plastic portion, which forms an inner part of the plastic structure and is formed integrally with the outer plastic portion from the inner side by the two-color molding. The lamp installing portion is formed integrally with the inner plastic portion from the inner side. The inner plastic portion has a transmission portion, which transmits light from the lamp.

### BRIEF DESCRIPTION OF THE DRAWINGS

FIG. 1A is a partial perspective view from diagonally behind illustrating a vehicle to which a vehicle plastic window is attached; and

FIG. 1B is a cross-sectional view taken along line 1B-1B of FIG. 1A.

### DETAILED DESCRIPTION OF THE PREFERRED EMBODIMENTS

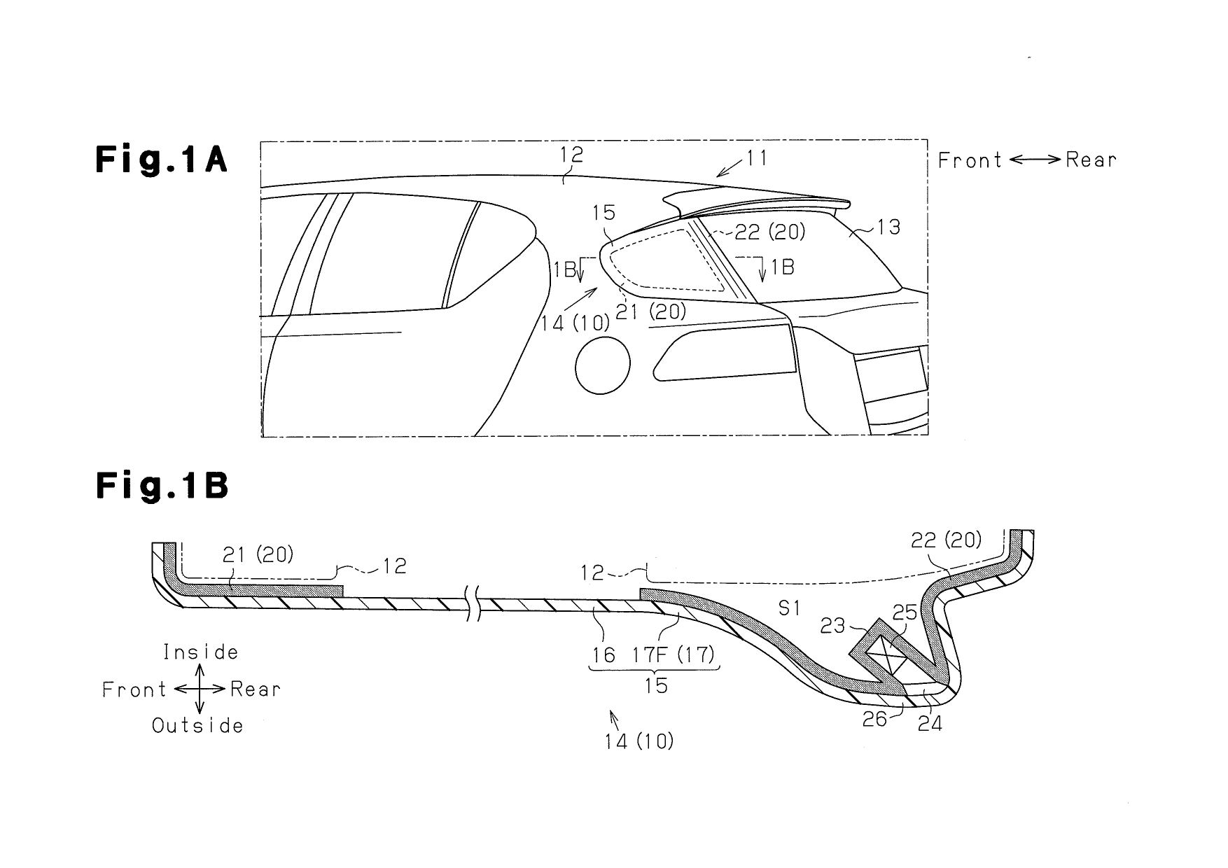

A vehicle plastic window according to one embodiment of the present invention will now be described with reference to FIGS. 1A and 1B. In the present embodiment, the vehicle plastic window is employed as a rear quarter window of a vehicle. In the description of the vehicle plastic window of the present invention, the front, rear, inside, and outside are defined as illustrated in FIGS. 1A and 1B.

As shown in FIG. 1A, a vehicle plastic window 10 for a vehicle is attached to a rear portion of a body 12 of a vehicle 11. The vehicle plastic window 10 is attached to either side of the vehicle 11. The vehicle plastic window 10 includes a plastic structure 14. As shown in FIG. 1B, the outer part of the plastic structure 14 is formed by an outer plastic portion 15, and the inner part of the plastic structure 14 is formed by an inner plastic portion 20. The outer plastic portion 15 and the inner plastic portion 20 are both made of a plastic material. The vehicle plastic window 10 has the following characteristics:

Light (low specific gravity)

Excellent impact resistance, hard to break

Easy to mold, and highly flexible in shaping (design)

Easy to color

The outer plastic portion 15 is adjacent to a back window 13 of the vehicle 11 and is attached to a side of the body 12. The outer plastic portion 15 is made of transparent plastic glass (organic glass). As plastic glass may be, for example, polycarbonate (PC) and polymethyl methacrylate. The outer plastic portion 15 is formed by the injection molding. The term “transparent” in the present description includes not only a colorless and transparent state, but also a transparent and colored state. The outer plastic portion 15 has a curved three-dimensional shape. The outer plastic portion 15 includes a flat section 16, which extends along the body 12, and a protrusion 17. The protrusion 17 is located rearward of the flat section 16 and protrudes outward. A space S1 is formed between the protrusion 17 and the body 12.

A front section 17F is located at the boundary between the protrusion 17 and the flat section 16. The front section 17F is gently curved to be concave as viewed from the outside. The outer surface of the protrusion 17 is flush with and continuous to the outer surface of the flat section 16. That is, the outer surface of the protrusion 17 is smoothly connected to the outer surface of the flat section 16. Thus, neither gap nor step exists at the boundary between the flat section 16 and the protrusion 17. As described above, the surface of the outer plastic portion 15 is a flush surface.

Fixing portions (not shown) are located on the inner side the outer plastic portion 15 to fix the outer plastic portion 15 to the body 12. The fixing portions are each provided in the front and the rear of the outer plastic portion 15. The structure of the fixing portions is not particularly limited. If the outer plastic portion 15 is made of polycarbonate, a hard coating layer may be formed on the outer surface of the outer plastic portion 15 to prevent scratches.

The inner plastic portion 20 is made of, for example, blackened polycarbonate or a polymer blend that is a blackened mixture of polycarbonate and polyethylene terephthalate (PET). The inner plastic portion 20 is formed to be opaque by the two-color molding. The two-color molding is a molding method for combining and integrating two different materials. In the two-color molding, the outer plastic portion 15, which is on the primary side, is molded first. Then, in the same mold, the inner plastic portion 20, which is on the secondary side, is molded. The outer plastic portion 15 and the inner plastic portion 20 are thus integrally molded.

The inner plastic portion 20 is formed integrally with the outer plastic portion 15 from the inner side. The inner plastic portion 20 extends to form a loop along the entire periphery of the outer plastic portion 15. Hereinafter, the front portion of the inner plastic portion 20 will be referred to as a front inner plastic portion 21, and the rear portion of the inner plastic portion 20 will be referred to as a rear inner plastic portion 22. The front inner plastic portion 21 is located on the outer side of the fixing portions located at the front of the outer plastic portion 15. The rear inner plastic portion 22 is located on the outer side of the fixing portions and the lamp installing portion 23 at the rear of the outer plastic portion 15. A part of the rear inner plastic portion 22 is located in the space S1 and on the inner side of the protrusion 17. The plastic structure 14 has a laminated structure at a position where the inner plastic portion 20 is located on the inner side of the outer plastic portion 15. Also, the plastic structure 14 has a single layer structure in a part of the outer plastic portion 15 where the inner plastic portion 20 is not formed, that is, in a part surrounded by the inner plastic portion 20.

The lamp installing portion 23 is provided for receiving a lamp 25, which is form example, a brake lamp, a directional indicator, or a reversing lamp. For example, a light emitting diode (LED) is used as the lamp 25. The number of lamp 25 may be one or more. In the latter case, the lamps 25 may be arranged in the vertical direction. The lamp installing portion 23 is located in the space S1 and integrally formed with the rear inner plastic portion 22 from the inner side. The structure for attaching the lamp 25 to the lamp installing portion 23 is not particularly limited.

In the space S1, the rear inner plastic portion 22 has a transmission portion 24, which transmits light from the lamp 25. The transmission portion 24 may be a recessed opening formed in the lamp installing portion 23 or a hole extending through the rear inner plastic portion 22. The transmission portion 24 is formed simultaneously when the inner plastic portion 20 is molded. A translucent portion 26 is formed in a part of the protrusion 17 that corresponds to the transmission portion 24, that is, at the outermost part of the protrusion 17. The light of the lamp 25 is emitted to the outside though the translucent portion 26. As a modification, a protrusion may be formed on the inner side of the translucent portion 26, and the protrusion may be inserted in the transmission portion 24. In this case, the translucent portion 26 may be a lens.

Operation of the above described vehicle plastic window 10 will now be described.

When the vehicle plastic window 10 is attached to the body 12, the space S1 is formed between the body 12 and the protrusion 17. The space S1 is used as a space for the rear inner plastic portion 22, which has the transmission portion 24, and as a space for the lamp installing portion 23.

In this state, the lamp installing portion 23, in which the lamps 25 is installed, the rear inner plastic portion 22, in which the fixing portions are provided, and the outer plastic portion 15 are arranged in that order from the inner side toward the outer side in the rear of the vehicle plastic window 10. In the front of the vehicle plastic window 10, the front inner plastic portion 21, which has the fixing portions, and the outer plastic portion 15 are arranged in that order from the inner side toward the outer side.

When the vehicle plastic window 10 is viewed from the side of the vehicle 11, the interior of the vehicle is visible through the transparent outer plastic portion 15 surrounded by the inner plastic portion 20. At a part where the inner plastic portion 20 of the vehicle plastic window 10 is provided, only the opaque inner plastic portion 20 can be seen. When the vehicle plastic window 10 is viewed from rear of the vehicle 11, only the opaque rear inner plastic portion 22 can be seen.

The inner plastic portion 20 conceals the lamp installing portion 23, the fixing portions of the outer plastic portion 15, which are located on the inner side of the inner plastic portion 20. That is, since the lamp installing portion 23 and the fixing portions are concealed, the appearance of the vehicle plastic window 10 is improved. Also, the outer plastic portion 15 prevents the inner plastic portion 20 from influenced by external factors such as wind, rain, and external forces.

The inner plastic portion 20 is formed integrally with the outer plastic portion 15 from the inner side by the two-color molding. This achieves firmer attachment than adhesion of the inner plastic portion 20 to the outer plastic portion 15. The inner plastic portion 20 is thus prevented from being peeled off the outer plastic portion 15 by external factors. The favorable appearance of the vehicle plastic window 10 is therefore maintained for an extended period of time.

When the lamp 25, which is attached to the lamp installing portion 23, emits light, the light is transmitted through the transmission portion 24 of the rear inner plastic portion 22, and then passes through the translucent portion 26 of the outer plastic portion 15. The light of the lamp 25 is thus emitted to the outside of the vehicle 11.

When the vehicle is traveling, the protrusion 17, which protrudes outward, regulate the direction of airflow in favorable fashion. Accordingly, air that flows from the front to the rear along the body 12 is regulated by flowing along the protrusion 17. This improves the aerodynamic characteristics of the vehicle. Particularly, there is no gap nor step at the joint between the outer surface of the flat section 16 and the outer surface of the protrusion 17. In this case, the air resistance at the boundary between the flat section 16 and the protrusion 17 is suppressed to a low level, which allows air to flow smoothly. As a result, the aerodynamic characteristics of the vehicle are improved, and the wind roar is reduced. The improvement of the aerodynamic characteristics reduces the energy consumption, which improves the fuel economy of the vehicle. Further, the traveling performance and the traveling stability are improved. Also, the appearance at the boundary between the flat portion and the protrusion is improved.

The present embodiment as described above has the following advantages.

(1) The vehicle plastic window 10 includes the plastic structure 14. The outer part of the plastic structure 14 is formed by the transparent outer plastic portion 15. The inner part of the plastic structure 14 is formed by the opaque inner plastic portion 20 by the two-color molding. The lamp installing portion 23 is formed integrally with the rear inner plastic portion 22 from the inner side. The lamp installing portion 23 is provided for attaching the lamp 25, which emits light to the outside of the vehicle 11, to the vehicle plastic window 10. The rear inner plastic portion 22 has a transmission portion 24, which transmits light from the lamp 25. In this configuration, unlike a conventional configuration in which an opaque film is attached to the outer surface of a plastic panel, the inner plastic portion 20 is not peeled off the outer plastic portion 15. Also, the function of the inner plastic portion 20 for concealing the lamp installing portion 23 from the outside can be maintained for an extended period of time. The favorable appearance of the vehicle plastic window 10 is maintained.

(2) The outer plastic portion 15 has the protrusion 17, which protrudes outward from the body 12. The space S1 is formed between the protrusion 17 and the body 12. A part of the rear inner plastic portion 22 in the space S1 is formed on the inner side of the protrusion 17. The lamp installing portion 23 in the space S1 is integrally formed with the rear inner plastic portion 22 from the inner side. Also, the transmission portion 24 in the space S1 is formed in the rear inner plastic portion 22. This configuration allows air that flows from the front to the rear along the body 12 to be regulated by the protrusion 17. This improves the aerodynamic characteristics of the vehicle. As a result, the energy consumption is reduced, which improves the fuel economy of the vehicle 11. Also, the traveling performance, the traveling stability and the like of the vehicle 11 are improved. Further, when the vehicle 11 moves, the wind roar that is produced near the vehicle plastic window 10 is reduced.

Also, the space S1 between the protrusion 17 and the body 12 is used for accommodating the lamp installing portion 23. This eliminates the necessity for creating a space for accommodating the lamp installing portion 23.

(3) The outer plastic portion 15 has the flat section 16, which is located in front of the protrusion 17. The front section 17F, which is a curved surface, is located at the boundary between the protrusion 17 and the flat section 16. Also, the outer surface of the protrusion 17 is flush with and continuous to the outer surface of the flat section 16. The configuration achieves better aerodynamic characteristics of the vehicle 11 compared to a configuration in which a step exists at the boundary between the protrusion 17 and the flat section 16. Further, the appearance of the boundary between the flat section 16 and the protrusion 17, that is, the appearance of the front section 17F is improved.

(4) In association with the item (1), the lamp installing portion 23 and the inner plastic portion 20 can be simultaneously formed at the time of the two-color molding of the inner plastic portion 20. Thus, unlike a case in which the lamp installing portion 23 is formed separately from the inner plastic portion 20, the lamp installing portion 23 does not need to be assembled with in the rear inner plastic portion 22. This reduces the manufacturing costs of the vehicle plastic window 10.

The above described embodiment may be modified as follows.

The vehicle plastic window according to the present invention may be applied to windows other than rear quarter windows. For example, the present invention may be applied to a triangular window behind the front pillar. In this case, the lamp installing portion of the vehicle plastic window may receive a lamp for emitting light to around the feet of an occupant standing outside the vehicle. For example, the lamp is turned on when the door is unlocked to illuminate around the feet of an occupant outside the vehicle.

The inner plastic portion 20 may be colored in a color other than black as long as the lamp installing portion 23 and the fixing portions are hard to visually recognize.

The inner plastic portion 20 does not necessarily need to be formed around the entire periphery of the outer plastic portion 15, but may be formed only at parts that correspond to the lamp installing portion 23 and the fixing portions.

In the protrusion 17, parts other than the front section 17F, which is the boundary with the flat section 16, may be curved.

It is sufficient if at least a part of the rear inner plastic portion 22 is located in the space S1 and on the inner side of the protrusion 17. Therefore, the entire rear inner plastic portion 22 may be located in the space S1 and on the inner side of the protrusion 17.

1. A vehicle plastic window attached to a body of a vehicle, the vehicle plastic window being formed by a plastic structure and having a lamp installing portion in which a lamp for emitting light to the outside of the body is installed, the plastic window comprising:
a transparent outer plastic portion, which forms an outer part of the plastic structure; and
an opaque inner plastic portion, which forms an inner part of the plastic structure and is formed integrally with the outer plastic portion from the inner side by the two-color molding, wherein
the lamp installing portion is formed integrally with the inner plastic portion from the inner side, and
the inner plastic portion has a transmission portion, which transmits light from the lamp.

2. The vehicle plastic window according to claim 1, wherein
the outer plastic portion is adjacent to a back window of the vehicle and is attached to a side of the body,
the outer plastic portion includes a protrusion, which protrudes outward from the body and forms a space between the protrusion and the body,
at least a part of the inner plastic portion is located inside the space and on the inner side of the protrusion,
the lamp installing portion is located inside the space and formed integrally with the inner plastic portion from the inner side, and
the transmission portion is located inside the space and formed in the inner plastic portion.

3. The vehicle plastic window according to claim 2, wherein
the outer plastic portion includes a flat section located in front of the protrusion,
the flat section extends in a front-rear direction of the vehicle,
at least a boundary between the protrusion and the flat section is formed to be curved, and
the outer surface of the protrusion is flush with and continuous to the outer surface of the flat section.
